(19) United States
(12) Patent Application Publication
(10) Pub. No.: US 2021/0218737 A1
(43) Pub. Date: Jul. 15, 2021

(54) AUTOCONFIGURATION OF MACSEC BETWEEN DEVICES

(71) Applicant: Cisco Technology, Inc., San Jose, CA (US)

(72) Inventor: Mahasen Bhagvath, Bangalore (IN)

(73) Assignee: Cisco Technology, Inc.

(21) Appl. No.: 16/742,627

(22) Filed: Jan. 14, 2020

(51) Int. Cl. H04L 29/06; H04L 9/08; H04L 9/32; H04W 12/04; H04W 12/06

(52) U.S. Cl. CPC H04L 63/0869; H04L 63/061; H04L 63/0876; H04W 12/0609; H04L 9/3228; H04W 12/04033; H04L 9/0822

(57) ABSTRACT

Techniques and mechanisms for autoconfiguring MACSec sessions between two electronic devices. During a discovery process, the electronic devices obtain information about each other's MAC Sec capabilities by receiving proprietary or organization-defined time length values (TLVs) within protocol data units (PDUs) that are exchanged between the two electronic devices utilizing the discovery protocol. Once the MACSec capabilities are known, the electronic devices may mutually authenticate themselves using an appropriate security protocol. One of the electronic devices may then be selected to autogenerate the connectivity association key (CAK) and connectivity association key name (CKN). The generating device may share the CAK and CKN with the other electronic device. The electronic devices may each generate the integrity check value key (ICK) and key encrypting key (KEK). Using the ICK and KEK, the two electronic devices may begin with the MAC Sec key agreement protocol (MKA) handshake to establish a MACSec session between them.

### TECHNICAL FIELD

The present disclosure relates generally to automatically establishing a media access control (MAC) security (MACSec) session between two electronic devices using a discovery protocol.

### BACKGROUND

In computer networking, many electronic devices, e.g., computers, peripheral devices, servers, switches, mobile devices, etc., may wish to communicate with other devices within a network, e.g., “neighboring” devices. For example, an organization may provide or host a network, e.g., an Ethernet network, wherein multiple electronic devices may wish to communicate with other electronic devices over the network. Currently, media access control (MAC) security (MACSec) is an 802.1AE IEEE industry standard security protocol that provides secure communication for all traffic on Ethernet links. MACSec provides point-to-point security on Ethernet links between directly connected nodes and is capable of identifying and preventing most security threats, including denial of service, intrusion, man in the middle, masquerading, passive wiretapping, and playback attacks. MACSec may also be established between non-neighbor devices over a tunnel. MACSec allows for the securing of an Ethernet link for almost all traffic, including frames from a discovery protocol, e.g., link layer discovery protocol (LLDP), link aggregation control protocol (LACP), dynamic host configuration protocol (DHCP), address resolution protocol (ARP), and other protocols that are not typically secured on an Ethernet link because of limitations with other security solutions. MACSec can be used in combination with other security protocols such as IP security (IPSec) and secure sockets layer (SSL) protocol to provide end-to-end network security.

Currently, there are two ways by which MACSec between two devices may be configured. One way is through pre-shared keys and the other is through 802.1x (IEEE 2010 standard). In the first method, the keys connectivity association key (CAK) and connectivity association key name (CKN), which are required to start a MACSec session, are configured manually on the electronic devices. In the second method, one of the electronic devices acts as a supplicant and the other electronic device acts as an authenticator. The supplicant is mutually authenticated with an authentication, authorization, and accounting (AAA) server using extensible authentication protocol (EAP)-transport layer security (TLS) or other similar EAP methods which support mutual authentication. The AAA server provides the “EAP-Key-Name” and Microsoft point-to-point encryption (MPPE) send and receive keys to the authenticator after successful authentication of the supplicant. The supplicant already has this information as it is part of the EAP Session with the AAA server. The authenticator and supplicant generate the required CAK and CKN keys in parallel, and the integrity check value key (ICK) and key encrypting key (KEK) are generated using CAK and CKN to establish a MACSec session between the two electronic devices. In both of the described methods, manual intervention is required to either configure the pre-shared keys on the electronic devices or to configure 802.1x on the managed electronic devices. Likewise, in the 802.1x method, use of a AAA server is required. Thus, if a large enterprise or data center network has a large number of electronic devices that need to establish MACSec sessions among themselves, then configuring the devices or pushing the configuration through a network management system (NMS) to these devices itself becomes a large and time consuming task.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 schematically illustrates an example of an organization hosting a network, e.g., an Ethernet network, in which PDUs according to a discovery protocol are exchanged among electronic devices to determine MACSec capabilities of the electronic devices based on TLVs contained in the PDUs.

FIG. 2 schematically illustrates example definitions for TLVs of the PDUs of FIG. 1.

FIG. 3 schematically illustrates two switches of two electronic devices of FIG. 1 and also includes a flow diagram that schematically illustrates an example process between the two switches for establishing a MACSec session using a custom TLV of FIG. 2.

FIG. 4 illustrates a flow diagram of an example method for an electronic device, in the network of the organization of FIG. 1 for establishing a MACSec session with other electronic devices in the network.

FIG. 5 is a computer architecture diagram showing an illustrative computer hardware architecture for implementing a routing device that can be utilized to implement aspects of the various technologies presented herein.

### DESCRIPTION OF EXAMPLE EMBODIMENTS

### Overview

This disclosure describes techniques for autoconfiguring MACSec between two electronic devices. Using a discovery protocol, e.g., a link layer discovery protocol (LLDP) or a proprietary discovery protocol such as, for example, Cisco Discovery Protocol, Foundry Discovery Protocol, Nortel Discovery Protocol and Link Layer Topology Discovery. Thus, utilizing these techniques, neighboring electronic devices can get to know about each other's MACSec capabilities using proprietary or organizationally-specific-defined time length values (TLVs) included within protocol data units (PDUs) that are exchanged via the discovery protocol. Once the capabilities are known, the devices may mutually authenticate themselves using, for example, public certificates, SSL/TLS protocol, secure shell (SSH) protocol, etc. In configurations, one of the electronic devices may then be selected or “elected” to autogenerate the connectivity association key (CAK) and connectivity association key name (CKN). The generating device may then share the CAK and CKN with the other electronic device securely. Now that both of the electronic devices have the same CAK and CKN keys, they may each generate the integrity check value key (ICK) and key encrypting key (KEK). Using the ICK and KEK, the two devices may begin with the MACSec key agreement protocol (MKA) handshake to establish a MACSec session between them.

In particular, a method in accordance with techniques described herein may include a first switch of a first electronic device sending first data to a second switch of a second electronic device. The first data may indicate capability of the first switch with respect to a MACSec protocol. The first switch may receive from the second switch second data that indicates the capability of the second switch with respect to the MACSec protocol. The first switch may then initiate mutual authentication between the first switch and the second switch. Upon completion of the mutual authentication, the first switch may receive from the second switch a request for a secure connection. The secure connection may be established between the first switch and the second switch and the first switch may receive from the second switch a request for the CAK and the CKN. Receipt of the request may be based on the first switch being selected or “elected” to autogenerate the CAK and the CKN. The first switch may generate the CAK and the CKN and send the CAK and the CKN to the second switch via the secure connection. Based at least in part on the CAK and the CKN, a MACSec session may be established between the first switch and the second switch in accordance with the MACSec protocol. For example, using the CAK and the CKN, the first switch and the second switch may generate the ICK and KEK and perform the MKA handshake to form the MACSec session.

Additionally, the techniques described herein may be performed by a system and/or device having non-transitory computer-readable media storing computer-executable instructions that, when executed by one or more processors, performs the method described above.

### Example Embodiments

Generally, as previously noted, MACSec sessions are established between electronic devices by generating an ICK and a KEK using a CAK and a CKN. In order to establish a MACSec session between the two electronic devices, the same CAK and CKN needs to be present in both electronic devices. Using the ICK and KEK, two electronic devices may perform the MACSec key agreement protocol (MKA) handshake to establish a MACSec session between them. Once established, the two electronic devices may securely transmit data packets between themselves.

This disclosure describes techniques and mechanisms for autoconfiguring MACSec sessions between two electronic devices. Two electronic devices utilize a discovery protocol, for example, a link layer discovery protocol (LLDP) or some other discovery protocol, such as, for example, Cisco Discovery Protocol, Foundry Discovery Protocol, Nortel Discovery Protocol and Link Layer Topology Discovery to discover various pieces of information about each other. In accordance with configurations described herein, the electronic devices obtain information about each other's MACSec capabilities. This is achieved by utilizing proprietary or organization-defined time length values (TLVs) within protocol data units (PDUs) that are exchanged between the two electronic devices utilizing the discovery protocol. For example, if the link layer discovery protocol is utilized, then the organizational specific TLV-127 may be utilized to provide the information regarding the electronic devices' MACSec capabilities.

In configurations, once the electronic devices' capabilities are known, the devices may mutually authenticate themselves using, for example, public certificates, e.g., SSL/TLS protocol, SSH protocol, etc. Once the electronic devices are mutually authenticated, a secure connection may be established between the two electronic devices. One of the electronic devices may then be elected to autogenerate a CAK and a CKN. The generating device may then share the CAK and CKN with the other device over secure connection. Once both of the electronic devices have the CAK and CKN, the electronic devices may both generate an ICK and KEK. Using the ICK and KEK, the electronic devices may establish a MACSec session using a MKA handshake to form the MACSec session.

Thus, in particular, auto-provisioning of a MACSec session between two electronic devices within a network may include both electronic devices utilizing a discovery protocol. For example, if LLDP is utilized, PDUs may be exchanged between the devices. The PDUs include TLVs, where one of the TLVs provides an indication of each devices' MACSec capabilities.

The two electronic devices may then mutually authenticate themselves utilizing public certificates or other mechanisms. For example, a SSL handshake is one way to mutually authenticate utilizing public certificates. Once the mutual authentication is complete, a secure connection may be established between the two electronic devices.

One of the electronic devices may be elected as a key generator. The selection of one of the devices may be based upon a parameter defined within logic included on the electronic devices. For example, the parameter may be which of the electronic devices includes the lowest MAC address, which of the electronic devices includes the highest MAC address, which of the electronics devices includes a newest version of operating software, etc. The selected key generator may then generate the CAK and the CKN. The key generator may then share the CAK and CKN with the other electronic device over the secure connection.

Utilizing the CAK and the CKN, both of the electronic devices may generate the ICK and KEK in parallel. Utilizing the ICK and KEK, the two electronic devices may then perform the MKA handshake. Since both of the electronic devices have the same CAK and CKN, the MKA handshake should be successful and a MACSec session should be established between the two electronic devices.

Thus, as can be seen, the MACSec session may be established among all MACSec capable links of a network, e.g., electronic devices, without any manual intervention. Additionally, the use of a AAA server is not necessary. Since the CAK and the CKN are randomly auto-generated, different MACSec sessions will have different keys and there is no need to manually generate them. Additionally, there is no need to enable 802.1x on the electronic devices for mutual authentication. Also, once a discovery protocol is enabled on electronic devices of a network, which is generally enabled by default, MACSec sessions may be established across all MACSec capable links of the network without any further configuration. This is not possible with current prior art methods previously discussed.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

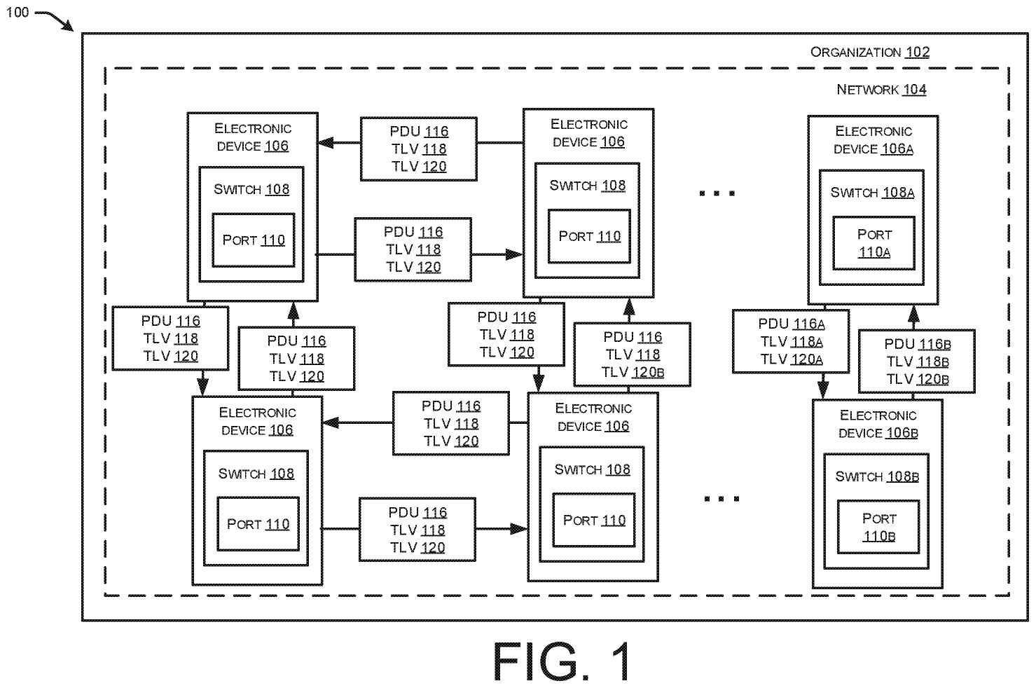

FIG. 1 schematically illustrates example 100 of an organization 102. The organization 102 provides or hosts a network 104, e.g., an Ethernet network. Example 100 further illustrates multiple electronic devices 106. The electronic devices 106 may be any suitable electronic device that are capable of communicating with other electronic devices via the network 104. For example, and without limitation, the electronic devices 106 may be any one of a computer, a server, a peripheral device such as, for example, a printer, a facsimile machine, etc., a mobile electronic device such as, for example, a smart phone, a laptop computer, a tablet, a notebook, etc. Each of the electronic devices 106 include at least one switch 108. Each switch includes one or more ports 110. In configurations, one or more of the ports 110 on each electronic device 106 is configured to perform MACSec encryption. In the example 100 of FIG. 1, only a single switch 108 including a single port 110 is illustrated for each electronic device 106 but it is to be understood that each electronic device 106 may include multiple switches 108 and/or multiple ports 110.

Each of the electronic devices include a discovery protocol 112. For example, the discovery protocol 112 may be configured in accordance with LLDP or some other discovery protocol, such as, for example, Cisco Discovery Protocol, Foundry Discovery Protocol, Nortel Discovery Protocol and Link Layer Topology Discovery to discover various pieces of information about each other. The discovery protocol 112 may incudes a database 114. Each of the electronic devices 106 are configured to exchange PDUs 116 that include TLVs 118 in accordance with the discovery protocol 112. In configurations, as discussed previously and will be discussed further herein, the PDUs 116 include custom TLVs 120 that are configured to indicate the MACSec capabilities for the corresponding electronic device 106. The PDUs 116 may be exchanged by the electronic devices 106 via their corresponding switches 108 and ports 110. As is known, each of the electronic devices 106 generally includes more components, depending upon the type of electronic device 106, which are not illustrated and described herein for clarity purposes.

Each of the electronic devices 106 within the organization 102 may wish to establish a MACSec session with another electronic device 106. In order to establish a MACSec session, two electronic devices 106a and 106b, for example, may exchange data that indicates each device's MACSec capabilities. For example, if the discovery protocol 112 is configured in accordance with LLDP, then the two electronic devices 106a, 106b may exchange PDUs 116a, 116b via ports 110a and 110b, where each PDU 116a, 116b includes multiple TLVs 118a, 118b, respectively.

In configurations, one of the TLVs 118a, 118b indicates the MACSec capabilities for the corresponding electronic device 106a, 106b, as will be discussed further herein. For example, the electronic device 106a may send the PDU 116a to the electronic device 106b. The PDU 116a sent by the electronic device 106a includes a TLV 120a that indicates electronic device 106a's MACSec capabilities. Since in this example, the discovery protocol 112 is configured in accordance with LLDP, TLV-127 may be utilized as TLV 120a to provide the MACSec capabilities, as will be discussed further herein. Likewise, the PDU 116b sent by the electronic device 106b includes a TLV 120b, e.g., TLV-127, that indicates electronic device 106b's MACSec capabilities. Based on the MACSec capabilities, the two electronic devices 106a, 106b may establish a MACSec session as has been discussed previously and as will be discussed further herein.

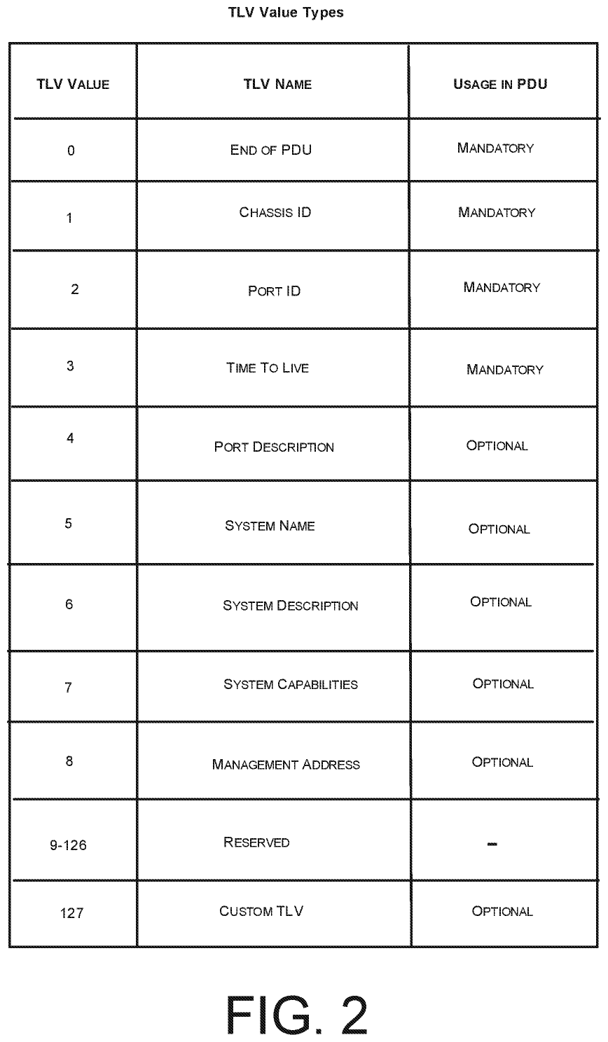

FIG. 2 schematically illustrates example definitions for TLVs 118. The example definitions are based on the discovery protocol 112 being configured in accordance with LLDP. Thus, the TLV definitions may be different if the discovery protocol 112 utilized by the network 104 and the electronic devices 106 is configured differently.

As is known, LLDP information or data is sent by the electronic devices 106 at a fixed interval in the form of an Ethernet frame. Each frame includes one LLDP Data Unit (LLDPDU), which are referred to herein as PDUs 116. As previously noted, each PDU 116 is made up of TLVs 118. Each of the TLVs 118 have a Type comprising 7 bits, a Length comprising 9 bits, and a Value comprising 0-511 octets. Thus, as may be seen in FIG. 2, TLV type 127 is a custom TLV that is optional and may be organizationally defined, e.g., proprietary and defined by organization 102. In configurations, TLV 120a and 120b of FIG. 1 are custom TLVs. The value of a custom TLV starts with a 24-bit organizationally unique identifier and a 1 byte organizationally specific subtype followed by data. Thus, a basic format for an organizationally specific TLV may be Type comprising 7 bits, Length comprising 9 bits, organizationally unique identifier comprising 24 bits, organizationally defined subtype comprising 8 bits, and organizationally defined information string comprising 0-507 octets. Accordingly, as described herein, such a custom TLV may be defined by the organization 102 such that electronic devices 106 may share MACSec capabilities with each other.

In particular, in configurations, such a proprietary TLV, e.g., organizational specific TLV 127, may be a single byte of data, where each bit may give certain information related to MACSec capability. For example, the first bit, e.g., the least significant bit, may provide MACSec capability for an electronic device 106, e.g., electronic device 106a and its switch 108a and port 110a. This least significant bit may be set to indicate that the port 110a of the switch 108a, is MACSec capable. The second bit may provide authentication. This second bit may determine if mutual authentication is initiated with another electronic device 106, e.g., electronic device 106b, or not. If the second bit is set, then it may mean mutual authentication is initiated. The third bit may provide authentication status. This third bit may be set to indicate that mutual authentication with the other electronic device 106b is successful. The fourth bit may indicate key generator. This bit may be set to indicate that the switch 108a is the key generator for CAK and CKN for the port 110a. The remaining bits may be used to indicate the MACSec encryption algorithm supported by the port 110a. For example, the advanced encryption standard-Galois counter mode (AES-GCM) 128, AES-GCM-256, etc. If one port, e.g., port 110a of electronic device 106a, supports 256-bit encryption and the port 110b of the other electronic device 106b supports 128-bit encryption, then a fallback action may happen for both ports 110a, 110b to perform 128-bit encryption.

The key generator mentioned above is different from the key server defined under MKA protocol. The key generator described with regard to the fourth bit generates the CAK and CKN, whereas the key server in MKA protocol generates secure association keys (SAKs). In configurations, the key generator may be selected based upon a parameter defined within logic included on the electronic devices 106. For example, the port 110 with the lowest MAC address may become the key generator to generate the CAK and CKN. In other examples, the port 110 with the highest MAC address may become the key generator to generate the CAK and CKN. Another example may be the newest version of operating software included on an electronic device 106. Other parameters may be used as desired.

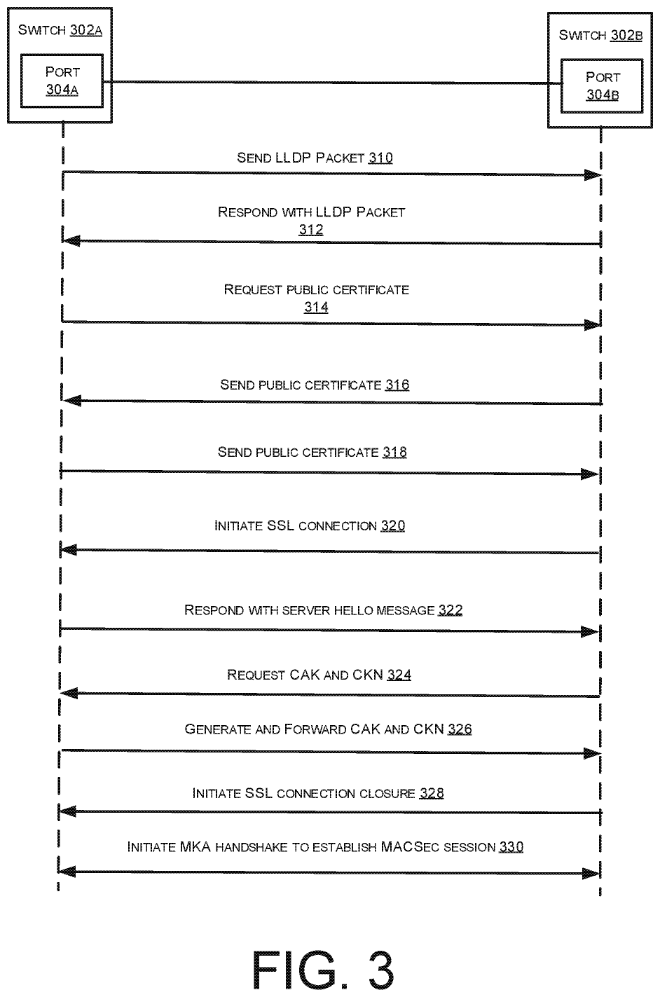

FIG. 3 schematically illustrates a first switch 302a and a second switch 302b. Switches 302a and 302b may correspond to switches 108a and 108b, respectively, of FIG. 1. Each of switch 302a and 302b includes one or more ports 304. Switch 302a and switch 302b may be connected via communication conduit 306 through, for example, port 304a and port 304b, which may correspond to ports 110a and 110b, respectively, of FIG. 1. The two switches 304a and 304b may then exchange PDUs 116 between them, where the PDUs 116 are in accordance with the discovery protocol 112. Thus, in configurations, the PDUs 116 include TLVs 118 and in particular, proprietary TLVs 120 that may be defined by the organization 102.

FIG. 3 also includes a flow diagram that schematically illustrates an example process between switch 302a and 302b for establishing a MACSec session using the previously described proprietary TLV 120 of FIG. 1. In the example, switch 302a is utilizing port 304a, which is an Ethernet configured port, while switch 302b is using port 304b, which is also an Ethernet configured port.

At 310, switch 302a sends a LLDP packet, e.g., PDU 116, that includes MACSec capability within a custom TLV, e.g., custom TLV 120, to switch 302b. The custom TLV indicates that switch 302a is MACSec capable. At 312, switch 302b responds with a LLDP packet, e.g., PDU 116, to switch 302a that includes a custom TLV, e.g., TLV 120. The custom TLV indicates that switch 302b is also MACSec capable.

At 314, switch 302a requests switch 302b's public certificate in order to initiate mutual authentication. At 316, switch 302b sends its public certificate to switch 302a using a PDU. At 318, switch 302a sends its public certificate for mutual authentication using a PDU.

After the exchange of public keys to establish mutual authentication, at 320, switch 302b, in this example, initiates a SSL connection, e.g., a secure connection, with switch 302a. In other examples, switch 302a may initiate the SSL connection. Thus, switch 302b sends a message, e.g., “client hello.” At 322, switch 302a responds with a message, e.g., “server hello.” After the exchange of messages, the generally known SSL/TSL handshake occurs to provide secure SSL connectivity. As previously noted, another form of mutual authentication may be utilized, including, for example, SSH protocol.

At 324, once the secure SSL connectivity is established, switch 302b requests CAK and CKN from switch 302a, as switch 302a has been selected, in this example, as key generator based upon a pre-defined parameter. For example, port 304a of switch 302a may have the lowest MAC address. At 326, switch 302a generates the CAK and CKN using a random number generator and forwards the CAK and CKN to switch 302b over the secure connection. In configurations, switch 302a may automatically generate and forward the CAK and the CKN as opposed to waiting for the request from switch 302b.

At 328, once the CAK and CKN are received by switch 302b, switch 302b, in this example, may initiate SSL connection closure, e.g., disconnection of the secure connection. In other example, switch 302a may initiate SSL connection closure. Once switch 302a and switch 302b have the same CAK and CKN, switch 302a and switch 302b may generate the ICK and KEK. In configurations, switch 302a and switch 302b may generate the ICK and KEK in parallel. At 330, switch 302a and switch 302b may then initiate a MKA handshake for establishing a MACSec session between ports 304a and 304b on switch 302a and switch 302b, respectively. In configurations, step 330, e.g., initiation of the SSL connection closure, may be initiated as opposed to after the CAK and CKN are received by switch 302b.

In configurations, if ports 304a and 304b do not have internet protocol (IP) addresses configured, temporary IP addresses may be shared through the LLDP and used until CAK and CKN are securely shared over the SSL connection between switch 302a and switch 302b. The temporary IP addresses may be included in the database 114 of the discovery protocol 112 of FIG. 1. Once the CAK and CKN shared, the temporary IP addresses may be flushed from the corresponding LLDP databases 114.

In configurations, if MACSec needs to be disabled, then the custom TLV 120 that indicates MACSec capability can be disabled globally, or at port level. If the custom TLV 120 is missing in a predetermined number of consecutive PDUs 116, then a MAC Sec session can be closed. As an example, which is not meant to be limiting, the predetermined number may be in a range of 3 to 6.

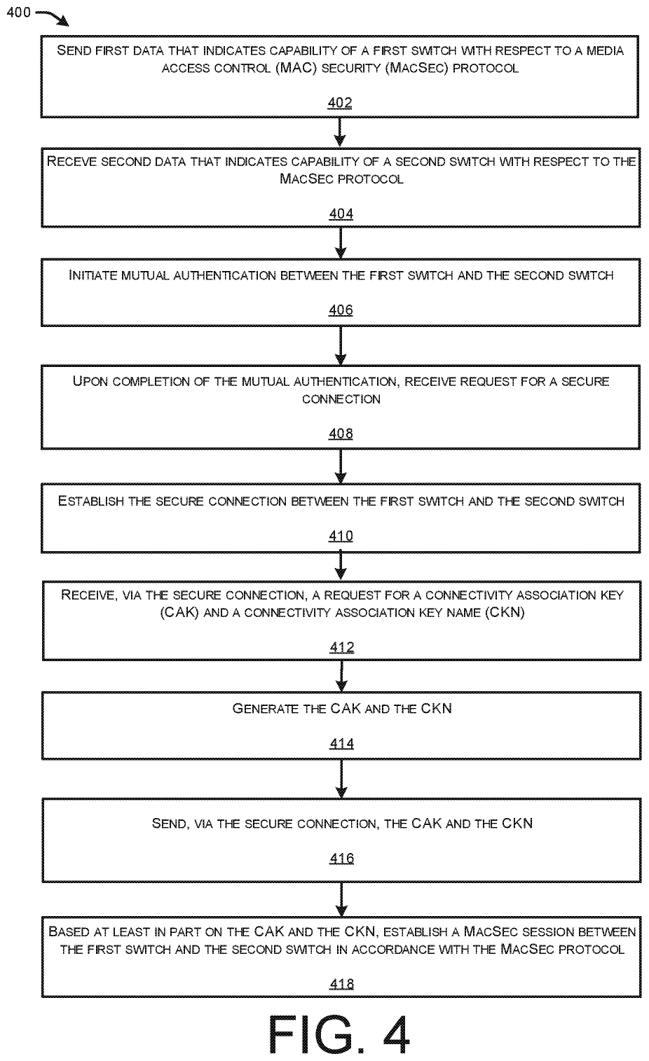

FIG. 4 illustrates a flow diagram of an example method 400 that illustrates aspects of the functions performed at least partly by the electronic devices 106 via the switches 108 and ports 110 as described in FIGS. 1-3. The logical operations described herein with respect to FIG. 4 may be implemented (1) as a sequence of computer-implemented acts or program modules running on a computing system and/or (2) as interconnected machine logic circuits or circuit modules within the computing system.

The implementation of the various components described herein is a matter of choice dependent on the performance and other requirements of the computing system. Accordingly, the logical operations described herein are referred to variously as operations, structural devices, acts, or modules. These operations, structural devices, acts, and modules can be implemented in software, in firmware, in special purpose digital logic, Application-Specific Integrated Circuit (ASIC), and any combination thereof. It should also be appreciated that more or fewer operations might be performed than shown in the FIG. 4 and described herein. These operations can also be performed in parallel, or in a different order than those described herein. Some or all of these operations can also be performed by components other than those specifically identified. Although the techniques described in this disclosure is with reference to specific components, in other examples, the techniques may be implemented by less components, more components, different components, or any configuration of components.

FIG. 4 illustrates a flow diagram of an example method 400 for an electronic device, e.g., electronic device 106, in a network 104 of an organization 102 for establishing a MACSec session with another electronic device. In some examples, the techniques of method 400 may be performed by a switch, e.g., switch 108, and/or a port, e.g., port 110. In such examples, the switch and/or port may comprise one or more hardware interfaces configured to send and receive packets, e.g., PDUs 116, in the network, one or more processors, and one or more non-transitory computer-readable media storing computer-executable instructions that, when executed by the one or more processors, cause the one or more processors to perform steps of method 400.

At 402, first data, e.g., PDU 116, is sent that indicates capability of a first switch, e.g., switch 108a, of a first electronic device, e.g., electronic device 106a, with respect to a media access control (MAC) security (MACSec) protocol. Thus, the first data may include custom TLV 120. For example, the first data may be sent by the first switch to a second switch of a second electronic device, e.g., second switch 108b, of electronic device 106b.

At 404, second data, e.g., PDU 116, that indicates capability of the second switch with respect to the MACSec protocol. Thus, the second data may include custom TLV 120. For example, the second data may be received by the first switch from the second switch.

At 406, mutual authentication may be initiated between the first switch and the second switch. For example, the first switch may initiate the mutual authentication. In configurations, the mutual authentication may include using one of SSL/TLS authentication protocol, or SSH authentication protocol.

At 408, upon completion of the mutual authentication, a request for a secure connection may be received. For example, the request may be received by the first switch from the second switch. At 410, the secure connection may be established between the first switch and the second switch.

At 412, a request may be received via the secure connection for a connectivity association key (CAK) and a connectivity association key name (CKN). For example, the request may be received by the first switch from the second switch.

At 414, the CAK and the CKN may be generated. For example, the CAK and the CKN may be generated by the first switch. At 416, the CAK and the CKN may be sent via the secure connection. For example, the first switch may send the CAK and CKN to the second switch via the secure connection. In configurations, the first switch may automatically generate and forward the CAK and the CKN via the secure connection as opposed to waiting for the request from the second switch.

At 418, based at least in part on the CAK and the CKN, a MACSec session between the first switch and the second switch may be established in accordance with the MACSec protocol. For example, the first switch and the second switch may each generate the ICK and KEK using the CAK and the CKN. The first switch and the second switch may then initiate a MKA handshake for establishing the MACSec session between the first switch and the second switch.

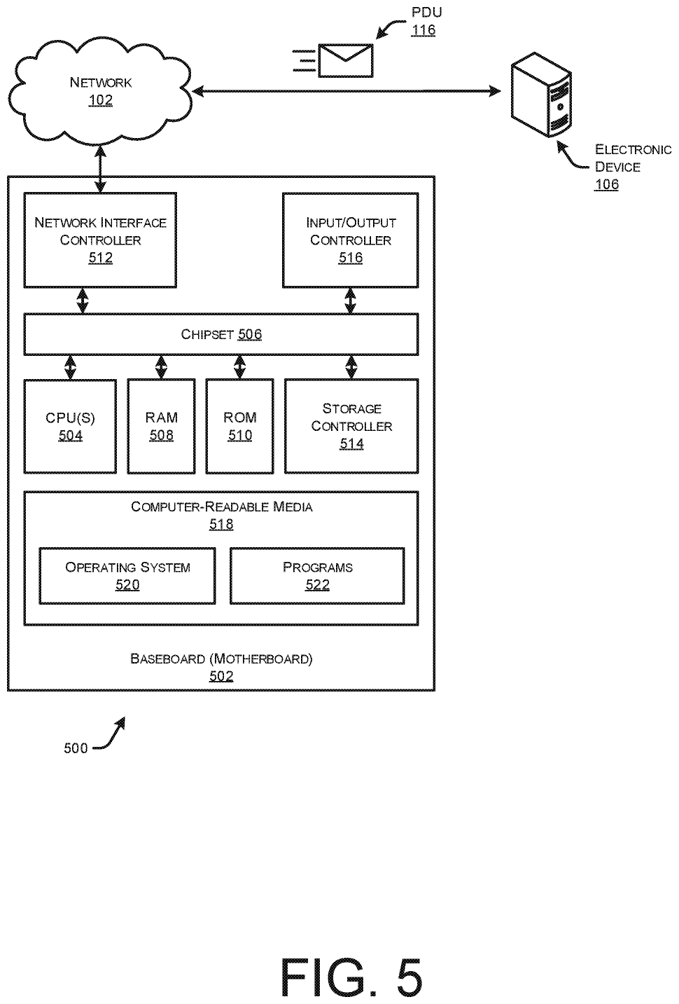

FIG. 5 shows an example computer architecture for a computer 500 capable of executing program components for implementing the functionality described above. The computer architecture shown in FIG. 5 illustrates an electronic device in the network 104 (e.g., electronic device 106) described herein, and may comprise a conventional server computer, workstation, desktop computer, laptop, tablet, network appliance, e-reader, smartphone, or other computing device, and can be utilized to execute any of the software components presented herein. In some examples, however, the computer 500 may correspond to networked devices such as servers, switches, routers, hubs, bridges, gateways, modems, repeaters, access points, etc., and can be utilized to execute any of the software components presented herein.

The computer 500 includes a baseboard 502, or “motherboard,” which is a printed circuit board to which a multitude of components or devices can be connected by way of a system bus or other electrical communication paths. In one illustrative configuration, one or more central processing units (“CPUs”) 504 operate in conjunction with a chipset 506. The CPUs 504 can be standard programmable processors that perform arithmetic and logical operations necessary for the operation of the computer 500.

The CPUs 504 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 506 provides an interface between the CPUs 504 and the remainder of the components and devices on the baseboard 502. The chipset 506 can provide an interface to a RAM 508, used as the main memory in the computer 500. The chipset 506 can further provide an interface to a computer-readable storage medium such as a read-only memory (“ROM”) 510 or non-volatile RAM (“NVRAM”) for storing basic routines that help to startup the computer 500 and to transfer information between the various components and devices. The ROM 510 or NVRAM can also store other software components necessary for the operation of the computer 500 in accordance with the configurations described herein.

The computer 500 can operate in a networked environment using logical connections to remote computing devices and computer systems through a network, such as the network 102. The chipset 506 can include functionality for providing network connectivity through a NIC 512, such as a gigabit Ethernet adapter. The NIC 512 is capable of connecting the computer 500 to other computing devices over the network 102. It should be appreciated that multiple NICs 512 can be present in the computer 500, connecting the computer to other types of networks and remote computer systems.

The computer 500 can be connected to a storage device 518 that provides non-volatile storage for the computer. The storage device 518 can store an operating system 520, programs 522, and data, which have been described in greater detail herein. The storage device 518 can be connected to the computer 500 through a storage controller 514 connected to the chipset 506. The storage device 518 can consist of one or more physical storage units. The storage controller 514 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 500 can store data on the storage device 518 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 518 is characterized as primary or secondary storage, and the like.

For example, the computer 500 can store information to the storage device 518 by issuing instructions through the storage controller 514 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 500 can further read information from the storage device 518 by detecting the physical states or characteristics of one or more particular locations within the physical storage units.

In addition to the mass storage device 518 described above, the computer 500 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 500. In some examples, the operations performed by the network 104, and or any components included therein, may be supported by one or more devices similar to computer 500. Stated otherwise, some or all of the operations performed by the network 104, and or any components included therein, may be performed by one or more computer devices 502 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 518 can store an operating system 520 utilized to control the operation of the computer 500. According to one embodiment, the operating system comprises the LINUX operating system. According to another embodiment, the operating system comprises the WINDOWS® SERVER operating system from MICROSOFT Corporation of Redmond, Wash. According to further embodiments, the operating system can comprise the UNIX operating system or one of its variants. It should be appreciated that other operating systems can also be utilized. The storage device 518 can store other system or application programs and data utilized by the computer 500.

In one embodiment, the storage device 518 or other computer-readable storage media is encoded with computer-executable instructions which, when loaded into the computer 500, transform the computer from a general-purpose computing system into a special-purpose computer capable of implementing the embodiments described herein. These computer-executable instructions transform the computer 500 by specifying how the CPUs 504 transition between states, as described above. According to one embodiment, the computer 500 has access to computer-readable storage media storing computer-executable instructions which, when executed by the computer 500, perform the various processes described above with regard to FIGS. 1-4. The computer 500 can also include computer-readable storage media having instructions stored thereupon for performing any of the other computer-implemented operations described herein.

The computer 500 can also include one or more input/output controllers 516 for receiving and processing input from a number of input devices, such as a keyboard, a mouse, a touchpad, a touch screen, an electronic stylus, or other type of input device. Similarly, an input/output controller 516 can provide output to a display, such as a computer monitor, a flat-panel display, a digital projector, a printer, or other type of output device. It will be appreciated that the computer 500 might not include all of the components shown in FIG. 5, can include other components that are not explicitly shown in FIG. 5, or might utilize an architecture completely different than that shown in FIG. 5.

The computer 500 may include one or more hardware processors 504 (processors) configured to execute one or more stored instructions. The processor(s) 504 may comprise one or more cores. Further, the computer 500 may include one or more network interfaces configured to provide communications between the computer 500 and other devices. The network interfaces may include devices configured to couple to personal area networks (PANs), wired and wireless local area networks (LANs), wired and wireless wide area networks (WANs), and so forth. For example, the network interfaces may include devices compatible with Ethernet, Wi-Fi™, IP protocols, and any other communication protocol.

The programs 522 may comprise any type of programs or processes to perform the techniques described in this disclosure for routing PDUs 116 through network 102 and establishing MAC Sec sessions among electronic devices 106 via switches 108 and ports 110. Additionally, the programs 522 may comprise instructions that cause the computer 500 to perform the techniques for mutually authenticating electronic devices 106 and corresponding switches 108 and ports 110 using various security protocols described herein. Generally, the programs 522 may comprise one or more modules or components to perform any of the operations described herein by any of the different types of devices/nodes described herein. In some instances, the programs may run inside of virtual machines, containers, and/or other virtual resources types.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method comprising:
sending, by a first switch of a first electronic device to a second switch of a second electronic device, first data that indicates capability of the first switch with respect to a media access control (MAC) security (MACSec) protocol;
receiving, by the first switch from the second switch, second data that indicates capability of the second switch with respect to the MACSec protocol;
initiating, by the first switch, mutual authentication between the first switch and the second switch;
upon completion of the mutual authentication, receiving, by the first switch from the second switch, a request for a secure connection;
establishing the secure connection between the first switch and the second switch;
receiving, by the first switch from the second switch via the secure connection, a request for a connectivity association key (CAK) and a connectivity association key name (CKN);
generating, by the first switch, the CAK and the CKN;
sending, by the first switch to the second switch via the secure connection, the CAK and the CKN; and
based at least in part on the CAK and the CKN, establishing a MACSec session between the first switch and the second switch in accordance with the MACSec protocol.

2. The method of claim 1, wherein:
the first data comprises a first protocol data unit (PDU), the first PDU configured in accordance with a discovery protocol and comprising a type-length-value (TLV) that indicates the capability of the first switch with respect to the MACSec protocol; and
the second data comprises a second PDU configured in accordance with the discovery protocol and comprising the TLV that indicates the capability of the second switch with respect to the MACSec protocol.

3. The method of claim 2, wherein the TLV is proprietary to an organization hosting a network within which the first switch and the second switch desire to establish the MACSec session.

4. The method of claim 1, wherein establishing the MACSec session comprises:
based at least in part on the CAK and the CKN, generating an integrity check value key (ICK) and key encryption key (KEK).

5. The method of claim 1, further comprising:
selecting the first switch to generate the CAK and the CKN based on a parameter.

6. The method of claim 5, wherein the parameter comprises one of (i) the first switch or the second switch having the lowest MAC, (ii) the first switch or the second switch having the highest MAC, or (iii) the first switch or the second switch having a most recent version of operating software.

7. The method of claim 1, further comprising:
after sending the CAK and the CKN, discontinuing the secure connection.

8. The method of claim 1, wherein the mutual authentication comprises one of (i) secure sockets layer (SSL)/transport layer security (TSL) protocol or (ii) secure shell (SSH) protocol.

9. An electronic device comprising a first switch, the first switch comprising:
one or more processors; and
one or more non-transitory computer-readable media storing computer-executable instructions that, when executed by the one or more processors, cause the one or more processors to:
send, to a second switch of a second electronic device, first data that indicates capability of the first switch with respect to a media access control (MAC) security (MACSec) protocol;
receive, from the first switch, second data that indicates capability of the second switch with respect to the MACSec protocol;
initiate mutual authentication between the first switch and the second switch;
upon completion of the mutual authentication, receive, from the second switch, a request for a secure connection;
establish the secure connection between the first switch and the second switch;
receive, by the first switch from the second switch, a request for a connectivity association key (CAK) and a connectivity association key name (CKN);
generate the CAK and the CKN;
send, to the second switch via the secure connection, the CAK and the CKN;
based at least in part on the CAK and the CKN, establish a MACSec session between the first switch and the second switch in accordance with the MACSec protocol.

10. The electronic device of claim 9, wherein:
the first data comprises a first protocol data unit (PDU), the first PDU configured in accordance with a discovery protocol and comprising a type-length-value (TLV) that indicates the capability of the first switch with respect to the MACSec protocol; and
the second data comprises a second PDU configured in accordance with the discovery protocol and comprising the TLV that indicates the capability of the second switch with respect to the MACSec protocol.

11. The electronic device of claim 10, wherein the TLV is proprietary to an organization hosting a network within which the first switch and the second switch desire to establish the MACSec session.

12. The electronic device of claim 9, wherein establish the MACSec session comprises:
based at least in part on the CAK and the CKN, generating an integrity check value key (ICK) and key encryption key (KEK).

13. The electronic device of claim 9, wherein the first switch comprises further computer-executable instructions that, when executed by the one or more processors, cause the one or more processors to:
select the first switch to generate the CAK and the CKN based on a parameter.

14. The electronic device of claim 13, wherein the parameter comprises one of (i) the first switch or the second switch having the lowest MAC, (ii) the first switch or the second switch having the highest MAC, or (iii) the first switch or the second switch having a most recent version of operating software.

15. The electronic device of claim 9, wherein the first switch comprises further computer-executable instructions that, when executed by the one or more processors, cause the one or more processors to:
after sending the CAK and the CKN, discontinue the secure connection.

16. A method comprising:
sending, by a first switch of a first electronic device to a second switch of a second electronic device, a first protocol data unit (PDU), the first PDU configured in accordance with a discovery protocol and comprising a type-length-value (TLV) that indicates capability of the first switch with respect to a media access control (MAC) security (MACSec) protocol;
receiving, by the first switch from the second switch, a second PDU, the second PDU configured in accordance with the discovery protocol and comprising the TLV that indicates capability of the second switch with respect to the media access control security (MACSec) protocol;
initiating, by the first switch, mutual authentication between the first switch and the second switch;
upon completion of the mutual authentication, receiving, by the first switch from the second switch, a request for a secure connection;
establishing the secure connection between the first switch and the second switch;
receiving, by the first switch from the second switch via the secure connection, a request for a connectivity association key (CAK) and a connectivity association key name (CKN);
generating, by the first switch, the CAK and the CKN;
sending, by the first switch to the second switch via the secure connection, the CAK and the CKN;
based at least in part on the CAK and the CKN, generating, by the first switch and second switch, an integrity check value key (ICK) and key encryption key (KEK); and
based at least in part on the ICK and the KEK, establishing a MACSec session between the first switch and the second switch in accordance with the MACSec protocol.

17. The method of claim 16, further comprising:
selecting the first switch to generate the CAK and the CKN based on a parameter.

18. The method of claim 17, wherein the parameter comprises one of (i) the first switch or the second switch having the lowest MAC, (ii) the first switch or the second switch having the highest MAC, or (iii) the first switch or the second switch having a most recent version of operating software.

19. The method of claim 16, further comprising:
after sending the CAK and the CKN, discontinuing the secure connection.

20. The method of claim 16, wherein the TLV is proprietary to an organization hosting a network within which the first switch and the second switch desire to establish the MACSec session.
